(19) United States
(12) Patent Application Publication
(10) Pub. No.: US 2005/0192378 A1
(43) Pub. Date: Sep. 1, 2005

(54) Printing ink composition and the method for printing

(76) Inventor: Yuh-Jye Uang, Chesterfield, MO (US)

Correspondence Address: Paul M. Denk, Suite 170, 763 S. New Ballas Rd., St. Louis, MO, 63141, US

(21) Appl. No.: 11/069,708

(22) Filed: Mar. 1, 2005

Related U.S. Application Data
(60) Provisional application No. 60/548,990, filed on Mar. 1, 2004.

(51) Int. Cl. C03C 17/00; C09D 11/00

(52) U.S. Cl. 523/160; 523/161

(57) ABSTRACT

Printing inks can be applied on the substrate of thermoplastic rubber compounds containing more than eighty percent (80%) mineral oil. The compositions of the ink include resins, mineral oil, solvents, colorants, and additives. The process involves preparing an optional base coat treatment on the substrate of the thermoplastic rubber compound. Next, print the desired multi-color image on the treated substrate following with a top coat on the surface of the substrate to protect the printed image. Pad printing is the process to print the image to surface of thermoplastic rubber compounds.

### CROSS REFERENCE TO RELATED APPLICATION

This nonprovisional patent application claims priority to the provisional patent application having Ser. No. 60/548,990, which was filed on Mar. 1, 2004.

### TECHNICAL FIELD OF THE INVENTION

This invention relates to the composition of printing inks, particularly, printing inks that can be applied by pad printing for multicolor printing. In this invention, the printing ink can be applied to the substrate of the thermoplastic rubber compound that contains styrenic block copolymer and mineral oil.

### BACKGROUND FOR THE INVENTION

In recent years, there are more and more commercial thermoplastic rubber products in bikes, gifts, toys and the medical industry. Soft, stretchable, and clear or transparent products in the area of amusement, imaginative play, and ornamentations are particularly attractive to consumers. However, thermoplastic rubber compounds containing mineral oil do not provide a good surface to achieve permanent marking by conventional printing methods such as pad printing, screen printing or hot foiling. A soft thermoplastic rubber compound with hardness below 1 OA makes it even more difficult. If the ink film's elasticity is lower than that of the substrate, the printed image will separate when stretch. Some investigation has been approached to make color printing on thermoplastic or rubber articles.

U.S. Pat. No. 3,519,466 to Akamatsu, et al, disclosed a process for printing on molded articles of a thermoplastic resin or a rubber. This process involves heating an ink containing a benzene-soluble reactive dye and a wetting agent soluble in benzene in contact with the surface of the molded article which contains an organo-metallic compound. When the article reaches a temperature higher than 50° C. but lower than the softening point of the article, the dye will permeates the article and reacts with the organo-metallic compound to become fixed therein. U.S. Pat. No. 6,367,384 to Cass, Donald W. reveals a process for printing a four color image directly onto a fishing lure. The process begins by preparing the soft bait fishing lure to receive the ink. By employing a four color pad printing machine, print a four color image on one side of the fishing lure and optionally turning the lure over to print on the other side. In their process, all the printing articles must be pretreated and a clear topcoat may optionally be applied to the lure.

The current available methods to apply images onto thermoplastic rubber compounds include either hand painting or spray. Since the composition of thermoplastic rubber compounds contains up to 80% mineral oil, it is very difficult for ink film to stick to the surface of the substrate. The present invention solves these problems by using the pad printing process to apply the image to thermoplastic rubber compounds directly and a topcoat to protect the applied image.

### SUMMARY OF THE INVENTION

The invention provides a very durable and stretchable ink image on the substrate of the thermoplastic rubber compounds. The printing process can be done with a pad printing machine. The printing ink contains resins, pigments, solvents, hydrocarbon oil and additives. Furthermore, the printing ink can have other interesting colors or effects, such as fluorescent ink, glitter powder, thermochromic ink that glows in the dark. It is just as likely that the thermoplastic rubber compounds, or other polymer compounds, upon which the printable ink is applied, may also include any thermoplastic rubber or polymer articles, as formed. Such articles can comprise either toys, housewares, or almost any type of item that can be made of these types of compounds and formed into such articles.

It is an object of the present invention to provide the formulation by varying the components in many different ways to produce the stretchable ink film on the substrate of deformable thermoplastic rubber products, which the shape can be either convex such as balls or flat as sheets. Further objects and advantages of the subject invention will be apparent to those skilled in the art.

### DETAILED DESCRIPTION OF THE INVENTION

The present invention of pad printing ink applied on the substrate of thermoplastic rubber compound, includes resins, mineral oil, solvents, pigments or dyes, and additives. The process involves optionally preparing the basecoat treatment on the substrate of thermoplastic rubber compound, printing multi-color image on the treated substrate of thermoplastic rubber compound. A clear topcoat can be applied either by pad printing or spray method.

Resins

The pad printing ink is composed of one or more resins. In most case the resins are obtained in the form of granulates or powders. The resins must be dissolved in a suitable solvent or solvents mixture. As a main component of the invention, the resins are responsible for the formation of the finished ink film and the carrier for the coloring material used in the ink formulation. The selection and combination of the resins determine the utilization of the ink's area and the resulting properties; such as adhesion to various substrates, grades of gloss, and resistance. Under the present invention, varying the amount and types of polymers affects the features of pad printing ink. For example, preferably using triblock, radical block and/or multiblock copolymers, and optionally a diblock copolymer the printing ink, which have desirable rheological properties, will produce a durable and stretchable ink film. The polymers used comprise at least one copolymer selected from the radical block and/or multiblock copolymers. This invention contains at least two thermodynamically incompatible segments, one hard and one soft. In general, in a triblock polymer, the ratio of the segments is one hard, one soft, and one hard or an A-B-A copolymer. The multiblock and radical block copolymer can contain any combination of hard and soft segments. In the optional diblock copolymer, the blocks are sequential with respect to hard and soft segments.

Commercially available thermoplastic rubber type polymers are especially useful in forming the compositions of the present invention. Kraton Chemical Company “and” Septon by Septon Company of America sell commonly used polymers. The most common structure is the linear ABA block type; styrene-butadiene-styrene (SBS) and styrene-isoprene-styrene (SIS) which is the Kraton D rubber series. Kraton G is another type of polymer. The copolymer comprises a styrene-ethylene-butylene-styrene (S-EB-S) structure. The Kraton G series is preferred in the practice of the invention. The optionally blended diblock polymers include the AB type such as styrene-ethylene-propylene (S-EP) and styrene-ethylene-butylene (S-EB), styrene-butadiene (SB) and styrene-isoprene (SI). Septon resins are available in either diblock (A-B) or the more common triblock) A-B-A) types. These include a hydrogenated poly-isoprene (S-EP, S-EP-S), a hydrogenated poly-isoprene/butadiene (S-EEP-S) polymer or a hydrogenated poly-butadiene (SEBS) polymer. Depending on the hardness of the substrate of the thermoplastic rubber compositions of ink, employing various combinations of triblock and radical block is necessary.

The pad printing ink preferably includes resins from about 1 to 12% by weight, more preferably from about 5 to 10% by weight, and still preferably from about 6 to 8% by weight.

Mineral Oil

Mineral oils are highly refined, colorless, and odorless petroleum oil. A preferred mineral oil to mix with thermoplastic rubber of the invention is the so-called “white” mineral oil. This type of mineral oil is generally recognized as safe for contact with human skin. Mineral oil may be characterized in terms of its density and viscosity, where light mineral oil is relatively less viscous than heavy mineral oil.

Light mineral oils are preferred for use in the invention. Mineral oils are available commercially in both USP and NF grades. USP mineral oils have viscosities that range from 35 to 125 cSt and pour points that range from −12° C. to −20° C. NF light mineral oils have lower viscosities, typically 3-30 cSt, and pour points as low as −40° C. The mineral oil may be of technical grade, having a viscosity ranging from 4-90 cSt and a pour point ranging from −12° C. to 2° C. Examples of commercially available suitable mineral oils include Sonneborn® and Carnation® white oils from Witco, Isopar® K and Isopar® H from ExxonMobil, and Drakeol®, Draketex®, Parole white mineral oils from Penreco Company. The amount of mineral oil in the pad printing ink should range from about 10 to 30% by weight based on the total weight of pad printing ink components, preferably from about 15 to 25% by weight.

Solvents

Solvents differ in their evaporation speeds and strengths. The amount of solvent in a pad printing ink is a major factor for its drying rate, printing speed and adhesion to the substrate. Solvents can be divided into thinners and retarders. Retarders are necessary when printing speed is slow and when drying ink system is extremely fast. Functioning as diluents in the corresponding ink system, thinners are a mixture of solvents. Mixing ink with thinners in the correct ratio to achieve the desired viscosity is extremely important. The viscosity of the final mixture will determine the effectiveness of the ink transfer. The type and amount of solvents will depend on the resins and pigment used in the ink system. In some cases, the substrates also play a role in determining which solvent should be used. The physical evaporation process of the solvents ink induces the drying of ink on substrate. At the same time the substrate of thermoplastic rubber compound is partially dissolved, the slight dissolution of the printing surface results in a direct bond between the ink and the substrate. In the present invention, both base coat and top coat uses aromatic solvents to increase the adhesion between the ink film and the substrate of thermoplastic rubber and very low evaporation rate of glycol ether acetate are used to reduce the volatile of aromatic solvents. The solvents uses in this invention can be arranged in the following chemical group: Aromatic Hydrocarbon, Ester, Glycol Ether Acetate and Ketone. For Aromatic solvents, Toluene, Xylenes, Aromatic 100, and Aromatic 150 are preferred. From the Ester group, isopropyl acetate and amyl acetate are preferred. In the Glycol Ether Acetate group, propylene glycol methyl ether acetate, ethylene glycol monoethyl ether acetate and ethylene glycol monobutyl ether acetate are preferred. Lastly, cyclohexanone, diacetone alcohol, and isophorone are preferred from the Ketone group.

Preferred are compositions employing the combination of Aromatic Hydrocarbon, Glycol Ether Acetate and Ketone. The pad printing ink preferably includes solvents from about 30 to 80% by weight, more preferably from about 45 to 70% by weight.

Colorants

Colorants provide the color tone of the ink and determine its hiding power. Colorants, either organic pigments or inorganic pigments, give color to a substrate by altering its reflective characteristics. There are hundreds of different types of pigment produced. Some are formed by nature in mineral or vegetable forms, but most are synthetic materials. When ink is applied to a substrate, colorants either remain on the surface or have a tendency to fill voids in irregular surfaces. The present invention contains a coloring agent that produces a desired color appearance. For this invention, organic pigments are preferred. The pigments may be those pigments suitable for use in printing ink; such type of pigment will be well known to those of ordinary skill in the art. Example of such pigments include, but are not limited to, pigment yellow 83 (C.I. 21108), pigment orange 34 (C.I. 21115), pigment red 48:3(C.I. 15865:3), pigment violet 23(C.I. 51319), pigment blue 15:2(C.I. 74160), pigment green 7 (C.I. 74260). Pigment white 6 (C.I. 77891) and pigment 7(C.I. 77266). In this invention, pigment makes up 10 to 30% by weight, preferably in an amount of about 15 to about 25% by weight.

Additives

The additives are substances normally used in small quantities. Their function is to adjust the ink properties, such as flow, viscosity, or characteristic of the surface. Adhesion modifiers, matting powder, anti-foam agent, wetting agent, antioxidant, antistatic agents, and flow control agents are a few examples. However, solvents have the most profound effect on printing performance.

In the preferred embodiment, the flow control agent may comprise an agent identified as Dapro S-65, available from Elementis Specialties, or an agent identified as BYK-307, available from BYK-Chemie USA, can also be utilized as a flow control agent.

Examples of the type of antioxidant that can be used include Tinogard TT, from Ciba Specialty Chemicals.

Examples of a wetting agents, which provides for better mixing of the various components of the composition, they include one identified as Aerosol OT-S, from Cytee Industry, or perhaps the BYK-345, from BYK-Chemie USA, can also be used as such an agent.

An example of an anti-foaming agent, in order to help the composition in a more liquid stage, during its mixing, and prevent the generation of any aeration in it, in order to get better flow and application, is one identified as Additive 56, from Dow Corning. Or, a BYK-022, from BYK-Chemie USA, can function just as well.

An example of an anti-static agent is one identified as Atmer 163, available from Uniqema.

Coating of Thermoplastic Rubber Substrate

Normally in the method of pad printing, it lays down a very thin ink film ranging from 4 to 6 micron thick. Optionally base coat pretreatment is to dissolve the substrate of the soft thermoplastic rubber to increase the adhesion between the ink films. Beside base coat treatment, the topcoat plays another very important role. The topcoat forms a stretch film sealing the printed image and preventing it from scratch. If the printed image needs better protection on the finish products, then another treatment can be used with the previous base coating materials. The compositions of either the clear basecoat or topcoat are resins, mineral oil, additives and solvents. The selection of polymers in the clear coating is the same as those in pad printing ink. The content of resins in the clear coating ranges from approximately 5 to 30% by weight, more preferably from about 10 to 25% by weight, and ideally from about 15 to 20% by weight. It is necessary to use fast-drying solvents for the basecoat while the retarder solvents for topcoat. Preferred are compositions employing the combination of aromatic solvents. The base coat should include solvent from about 35 to about 90% by weight, more preferably from about 50 to about 80% by weight, and ideally from about 60 to about 70% by weight. The solvent is used to make the irregular surface by dissolving the substrate of thermoplastic rubber. The mineral oil will be functioned as a retarder to prevent the either shrank or dissolution of the substrate due to the depth etching on the surface. The mineral oil is present in amounts ranging from about 5 to about 30% by weight, more preferably from about 10 to about 20% by weight.

### EXAMPLE 1

The multicolor pad-printing machine is used to print an image onto the thermoplastic rubber materials, which contain up to 80% mineral oil. The shapes of the thermoplastic rubber substrate can be smoothing convex such as ball, solid 3-D design features, and flat sheets. The content of the ball can be one or mixtures of the ingredient such as water, gel, thermochromic pigment, fluorescent pigment, or any shape of inserts. For example, in the three-color pad printing of a logo onto the surface of either ball products or flat sheets, the printing process is repeated four times, with three different colors of ink and one clear topcoat. The topcoat is applied by the pad printing method. Alternatively, the clear top coating can be applied by spray method. The method of the top coating should be selected based on the shape of the final products.

The invention has been described herein with the reference to certain preferred embodiments. It is understood that obvious variants thereon will become apparent to those skilled in the art. The invention is not to be considered as limited thereto.

1. A process for applying multicolor image to one of a thermoplastic rubber and polymer compound forming a product and having a surface structure receptive to receiving at least one applied printing ink, including applying a printing ink composition by a printing pad to the surface structure, and applying a top coat treatment of a transparent protective coating thereon.

2. The process according to claim 1 including a base coat applied by pad printing onto the surface structure of the thermoplastic compound to provide receptiveness to the application of the printing ink compositions.

3. The process of claim 1 wherein the printing ink composition comprises:
(a) one or more copolymer resins selected from the group consisting of a tailback, radical block and multi-block copolymer, and a die-block copolymer;
(b) mineral oil;
(c) solvent;
(d) colorant;
(e) and an additive to adjust the application characteristics of the printing ink, and to maintain its structural integrity.

4. The process of claim 3 and wherein said printing ink composition copolymers contains at least two thermodynamically incompatible segments, and said segments are selected from the group consisting of:
(a) Styrene-butadiene-styrene polymers;
(b) Styrene-isoprene-styrene polymers;
(c) Styrene-ethylene-butadiene-styrene polymers;
(d) Styrene-ethylene-propylene-styrene polymers;
(e) Styrene-ethylene-butylene-styrene polymers;
(f) Styrene-butadiene polymers; and
(g) Styrene-isoprene polymers.

5. The process of claim 4 and wherein said printing ink composition copolymers comprise between about one to twelve percent (1% to 12%) by weight of the said composition.

6. The printing in composition of claim 5 wherein said copolymers comprise between about five to ten percent (5% to 10%) by weight of the said composition.

7. The process of claim 3 wherein the mineral oil of the printing ink composition comprises between about ten to thirty percent (10% to 30%) by weight of the said composition.

8. The printing ink composition of claim 7 wherein said mineral oil comprises between about fifteen to twenty five percent (15% to 25%) by weight of the said composition.

9. The process of claim 3 wherein said printing ink composition solvent comprises between about thirty to eighty percent (30% to 80%) by weight of the said composition.

10. The printing ink composition of claim 9 wherein the solvent comprises between about forty-five to seventy-five percent (45% to 75%) by weight of the said composition.

11. The process of claim 3 wherein the printing ink composition pigments comprise between about ten to thirty percent (10% to 30%) by weight of the said composition.

12. The printing ink composition of claim 11 wherein said pigments comprise between about fifteen to twenty-five percent (15% to 25%) by weight of the said composition.

13. The process of claim 11 wherein said printing ink composition pigments further comprise at least one of:
(a) luminescent pigment;
(b) fluorescent pigment; and
(c) thermochromic pigment

14. The process of claim 3 wherein the printing ink composition includes at least one additional additive selected from the group consisting of an adhesion modifier, matting powder, antistatic agent, anti-foaming agent, wetting agent, antioxidant, a flow control agent, and a fragrance.

15. The process of claim 1 wherein the top coat treatment further comprises:
(a) one or more copolymer resins selected from the group consisting of a tailback, radical block and multi-block copolymer, and a die-block copolymer;
(b) a mineral oil; and
(c) solvents.

16. The top coat composition of claim 15 wherein each of said copolymers contains at least two thermodynamically incompatible segments, and are selected from the group consisting of:
(a) Styrene-butadiene-styrene polymers;
(b) Styrene-isoprene-styrene polymers;
(c) Styrene-ethylene-butadiene-styrene polymers;
(d) Styrene-ethylene-propylene-styrene polymers; and
(e) Styrene-ethylene-butylene-styrene polymers.

17. The top coat composition of claim 16 wherein said copolymers comprise between about five to thirty percent (5% to 30%) by weight of the said composition.

18. The top coat composition of claim 17 wherein said copolymers comprise between about ten to twenty-five percent (10% to 25%) by weight of the said composition.

19. The top coat composition of claim 15 wherein said mineral oil comprises between about five to thirty percent (5% to 30%) by weight of the said composition.

20. The top coat composition of claim 19 wherein said mineral oil comprises between about ten to twenty percent (10% to 20%) by weight of the said composition.

21. The top coat composition of claim 15 wherein said solvents comprise between about thirty-five to ninety percent (35% to 90%) by weight of the said composition.

22. The top coat composition of claim 21 wherein said solvents comprise between about sixty to seventy percent (60% to 70%) by weight of the said composition.

23. The top coat composition of claim 21, and further including an aromatic solvent, and said aromatic solvent including at least one of toluene, xylene and aromatic 100.

24. The process of claim 1 and wherein said printing ink is applied by pad printing onto the surface structure of the thermoplastic or polymer compound.

25. The process of claim 1 wherein said top coating is applied by pad printing onto the surface structure of the thermoplastic rubber or polymer compound.

26. The process of claim 1 wherein the top coating is applied by spray coating onto the printed image previously applied to the structured surface of the thermoplastic rubber or polymer compound.

27. The process of claim 1 wherein the structured shape of the thermoplastic rubber or polymer compound forming the structured surface can be either convex or flat.
